(19) United States
(12) Patent Application Publication
(10) Pub. No.: US 2024/0014625 A1
(43) Pub. Date: Jan. 11, 2024

(54) METHOD AND DEVICE FOR LOCKING REPETITION RATE OF OPTICAL FREQUENCY COMBS

(71) Applicant: BEIJING AEROSPACE INSTITUTE FOR METROLOGY AND MEASUREMENT TECHNOLOGY, Beijing (CN)

(72) Inventors: Zhitao ZHANG, Beijing (CN); Yinxiao MIAO, Beijing (CN); Tieli ZHANG, Beijing (CN); Xiaoqiang GAO, Beijing (CN); Yajun LIANG, Beijing (CN); Yongyao XU, Beijing (CN); Xiaoxu LIU, Beijing (CN); Yongchao ZHANG, Beijing (CN); Yan SONG, Beijing (CN)

(21) Appl. No.: 18/471,417

(22) Filed: Sep. 21, 2023

(30) Foreign Application Priority Data
Sep. 26, 2022 (CN) 202211177215.1

(51) Int. Cl. H01S 3/139; H01S 3/08

(52) U.S. Cl. CPC H01S 3/139; H01S 3/08086

(57) ABSTRACT

A method for locking repetition rate of an optical frequency comb is provided. A cavity length adjusting actuator is adopted to lock the repetition rate of the optical frequency comb. When a locking state of the cavity length adjusting actuator is in a critical threshold state, an optical delay line of an optical frequency comb optical system is adjusted to adjust the repetition rate of the optical frequency comb, so as to keep locking the repetition rate of the optical frequency comb. A locking device of the repetition rate is also provided, in which an optical delay line control system can judge the locking state of a cavity length adjusting actuator control system in real time, such that the repetition rate can be slowly adjusted within a wide range, and the locking state of the optical frequency comb can be maintained.

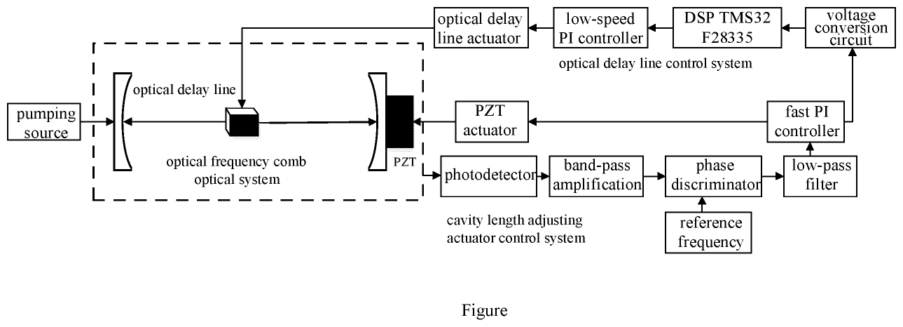

### CROSS-REFERENCE TO RELATED APPLICATIONS

This application claims the benefit of priority from Chinese Patent Application No. 202211177215.1, filed on Sep. 26, 2022. The content of the aforementioned application, including any intervening amendments thereto, is incorporated herein by reference in its entirety.

### TECHNICAL FIELD

The present disclosure relates to frequency control, and more particularly to a method and device for locking a repetition rate of optional frequency combs.

### BACKGROUND

As a bridge connecting microwave frequency and optical frequency, the optical frequency comb has been widely used in the optical frequency measurement in recent years due to its simple structure and low cost, and is considered as the most effective tool for the absolute optical frequency measurement so far. At the same time, in view of the interrelationship between the frequency, time and space scale, the optical frequency comb serves as an ideal tool for the time-frequency transfer, and measurement of absolute distance and absolute angle, and has a brilliant application prospect in manned spaceflight, deep space exploration, satellite timing and modern manufacturing industry. Moreover, the optical frequency comb can also achieve the precise qualitative and quantitative analysis of trace gases in the field of spectroscopic measurement. The temperature inversion can be performed based on spectra, which also makes the optical frequency comb applicable in the field of temperature measurement.

The long-time and high-precision locking of the repetition rate is the basis of application of the optical frequency comb. The drift of the repetition rate is closely related to the temperature changes. The temperature changes affect the laser cavity length of the optical frequency comb, resulting in the repetition rate drift. In the existing researches on the locking technology of the repetition rate of optical frequency combs, the locking bandwidth is small, and fails to enable the long-time precise locking of the repetition rate under large temperature changes. The field measurement has become increasingly frequent. In the field measurement, the large temperature variation and complex environmental condition will bring a great challenge to the precise locking of the repetition rate of the optical frequency comb. If the locking of the optical frequency comb is eliminated during the practical measurement process, it will seriously affect the accuracy and reliability of the measurement results.

### SUMMARY

In view of this, the present disclosure provides a method and device for locking a repetition rate of optical frequency combs, which can realize the high-precision and long-time locking under large temperature changes and complex environmental conditions.

The technical solutions adopted by the present disclosure are as follows.

In a first aspect, this application provides a method for locking a repetition rate of an optical frequency comb, comprising:
(S1) locking the repetition rate of the optical frequency comb with a cavity length adjusting actuator; and
(S2) when a locking state of the cavity length adjusting actuator is in a critical threshold state, adjusting the repetition rate of the optical frequency comb by adjusting an optical delay line of an optical frequency comb optical system to keep locking the repetition rate of the optical frequency comb.

In an embodiment, prior to step (S1), the method further comprises:
outputting, by the optical frequency comb optical system, a repetition rate signal to the cavity length adjusting actuator.

In an embodiment, the step (S1) comprises:
(S11) based on the repetition rate signal, obtaining a sinusoidal error signal for characterizing a phase difference between the repetition rate signal and a reference frequency signal; and
(S12) adjusting the repetition rate signal according to the sinusoidal error signal to complete locking of the repetition rate of the optical frequency comb.

In an embodiment, the step (S11) comprises:
converting the repetition rate signal into an electrical signal;
obtaining a fundamental signal or a high-order harmonic signal according to the electrical signal, and amplifying the fundamental signal or the high-order harmonic signal;
performing phase discrimination on an amplified fundamental signal or an amplified high-order harmonic signal amplified to obtain the phase difference; and
filtering the phase difference to obtain the sinusoidal error signal.

In an embodiment, the step (S2) comprises:
converting, by an optical delay line control system, an electrical signal output from the cavity length adjusting actuator into a voltage characteristic signal;
determining, by the optical delay line control system, whether the locking state of the cavity length adjusting actuator is in the critical threshold state based on the voltage characteristic signal, wherein when the locking state of the cavity length adjusting actuator is in the critical threshold state, the optical delay line of the optical frequency comb optical system is adjusted to adjust the repetition rate of the optical frequency comb.

In a second aspect, this application provides an optical frequency comb repetition rate locking device, comprising:
a cavity length adjusting actuator control system; and
an optical delay line control system;
wherein the cavity length adjusting actuator control system is configured to lock the repetition rate of the optical frequency comb; and
the optical delay line control system is configured to adjust an optical delay line of an optical frequency comb optical system to adjust the repetition rate of the optical frequency comb when a locking state of the cavity length adjusting actuator control system is in a critical threshold state, so as to maintain locking of the repetition rate of the optical frequency comb.

In an embodiment, the optical frequency comb repetition rate locking device further comprises:
the optical frequency comb optical system;
wherein the optical frequency comb optical system is configured for outputting a repetition rate signal to the cavity length adjusting actuator control system.

In an embodiment, the cavity length adjusting actuator control system comprises: a photodetector;
a band-pass amplifier module;
a phase discriminator;
a low-pass filter;
a first proportional-integral (PI) controller; and
a piezoelectric ceramic (PZT) actuator;
wherein the photodetector is configured for converting the repetition rate signal into a first electrical signal;
the band-pass amplifier module is configured for extracting a fundamental signal or a high-order harmonic signal according to the first electrical signal and performing amplification processing on the fundamental signal or the high-order harmonic signal;
the phase discriminator is configured for performing phase discriminating on an amplified fundamental signal or an amplified high-order harmonic signal amplified to obtain a phase difference between the repetition rate signal and a reference frequency signal;
the low-pass filter is configured for filtering the phase difference to obtain a sinusoidal error signal for characterizing the phase difference between the repetition rate signal and the reference frequency signal;
the first PI controller is configured for obtaining a first operation signal based on the sinusoidal error signal and outputting the first operation signal to the PZT actuator; and
the PZT actuator is configured for driving an amount of expansion and contraction of a piezoelectric ceramic for controlling the optical frequency comb optical system to accomplish locking of the repetition rate of the optical frequency comb.

In an embodiment, the optical delay line control system comprises:
a voltage conversion circuit;
a microprocessor;
a second PI controller; and
an optical delay line actuator;
wherein the voltage conversion circuit is configured for receiving a second electrical signal output from the first PI controller of the cavity length adjusting actuator control system and converting the second electrical signal into a voltage characteristic signal;
the microprocessor is configured for performing real-time sampling on the voltage characteristic signal for judgment, and outputting a sampled signal to the second PI controller when a difference between the voltage characteristic signal and a control threshold of the cavity length adjusting actuator control system is within a preset range;
the second PI controller is configured for obtaining a second operation signal based on the sampled signal and outputting the second operation signal to the optical delay line actuator; and
the optical delay line actuator is configured for adjusting the optical delay line of the optical frequency comb optical system to achieve adjustment of the repetition rate signal.

In an embodiment, the optical delay line is adjusted such that a voltage value of the voltage characteristic signal is 5 v; and an adjustment action of optical delay line actuator is kept unchanged, and the second PI controller is turned off to accomplish adjustment of the repetition rate signal.

The present disclosure has the following beneficial effects.
(1) Reading the method provided herein, a repetition rate of an optical frequency comb is locked with a cavity length adjusting actuator. When a locking state of the cavity length adjusting actuator is in a critical threshold state, an optical delay line of an optical frequency comb optical system is adjusted to adjust the repetition rate of the optical frequency comb, so as to keep locking the repetition rate of the optical frequency comb. An optical delay line control system can judge a locking state of a cavity length adjusting actuator control system in real time, such that the repetition rate of the optical frequency comb can be slowly adjusted within a wide range, thereby maintaining the locking state of the optical frequency comb. The present disclosure can realize the high-precision and long-time locking of the optical frequency comb repetition rate under large temperature changes and complex environmental conditions.
(2) The sinusoidal error signal obtained by using a phase discriminator and a low-pass filter is well smoothed, making the locking of the optical frequency comb repetition rate easier.
(3) The optical delay line control system can achieve the adjustment of the repetition rate of the optical frequency comb within a wide range (up to 100 kHz), facilitating the long-time locking of the optical frequency comb. The system can realize the ultra-wide-bandwidth, wide-range and precise locking of the optical frequency comb without affecting the mode locking of the optical frequency comb.

### DESCRIPTION OF THE DRAWINGS

This FIGURE is a structural block diagram of a device for locking repetition rate of optical frequency combs according to an embodiment of the present disclosure.

### DETAILED DESCRIPTION OF EMBODIMENTS

The present disclosure provides a method and device for locking a repetition rate of an optical frequency comb. A cavity length adjusting actuator is adopted to lock the repetition rate of the optical frequency comb. When a locking state of the cavity length adjusting actuator is in a critical threshold state, adjusting a repetition rate of an optical frequency comb by adjusting an optical delay line of an optical frequency comb optical system to keep locking the repetition rate of the optical frequency comb. An optical delay line control system can judge a locking state of a cavity length adjusting actuator control system in real time, realize a slow and wide-range adjustment of the repetition rate of the optical frequency comb, and maintain the locking state of the optical frequency comb. The present disclosure can realize a high-precision and long-time locking of the repetition rate of the optical frequency comb under large temperature changes and complex environmental conditions.

The present disclosure adopts a proportional integral (PI) controller with high dynamic response, supplemented by a cavity length adjusting actuator to adjust the cavity length of the laser to complete the locking of the repetition rate. The cavity length adjusting actuator mainly includes piezoelectric ceramics (PZT), electrically controlled polarization modulator, acousto-optic modulator (AOM) and electro-optic modulator, etc., which has the advantages of faster adjustment speed and higher locking accuracy.

The present disclosure will be described in detail below in conjunction with the drawings and embodiments.

The FIGURE is a structural block diagram of a device for locking a repetition rate of the optical frequency comb according to an embodiment of the present disclosure. As shown in the FIGURE, the device includes:
a pumping source;
an optical frequency comb optical system;
a cavity length adjusting actuator control system; and
an optical delay line control system.

The pump source is configured to provide pump light to the optical frequency comb optical system. The optical frequency comb optical system includes piezoelectric ceramics (PZT) and an optical delay line. The cavity length adjusting actuator control system includes a photodetector, a band-pass amplifier module (i.e., band-pass amplification in the FIGURE), a phase discriminator, a reference frequency module (i.e., reference frequency in the FIGURE), a low-pass filter, a fast PI controller, and a PZT actuator. The optical delay line control system includes a voltage conversion circuit, microprocessor (DSP TMS32 F28335 indicates the microprocessor model), a low-speed PI controller, and an optical delay line actuator.

The present disclosure provides a method for locking a repetition rate of an optical frequency comb using the device provided in the FIGURE, including the following steps.
(S1) The optical frequency comb optical system outputs a repetition rate signal to the cavity length adjusting actuator (i.e., cavity length adjusting actuator precision control system).

The optical frequency comb optical system outputs an optical signal characterized by the repetition rate of the optical frequency comb after a series of optical conversion. The optical frequency comb optical system, with the laser cavity constructed by optical components as a main part, inputs pump light with a certain optical power through a pumping source, and generates an optical signal with a certain frequency characteristic (i.e., a repetition rate signal) through optical transformations such as light enhancement and nonlinear phase shift in the laser cavity.
(S2) The repetition rate of the optical frequency comb is locked by the cavity length adjusting actuator.

In an embodiment, step (S2) includes the following steps.
(S21) The sinusoidal error signal used to characterize the phase difference between the repetition rate signal and the reference signal is obtained according to the repetition rate signal.
(S22) The repetition rate signal is adjusted according to the sinusoidal error signal to complete the repetition rate locking of the optical frequency comb.

In an embodiment, step (S21) includes the following steps.

The repetition rate signal is converted into a first electrical signal.

A fundamental signal or a high-order harmonic signal is obtained according to the first electrical signal, and amplified.

An amplified fundamental signal or high-order harmonic signal is subjected to phase discrimination to obtain the phase difference with the reference frequency signal.

The phase difference is filtered to obtain the sinusoidal error signal for characterizing the phase difference between the repetition rate signal and the reference frequency signal.

The optical comb optical system outputs a repetition rate signal, which is converted into an electrical signal through a photodetector, and then a sinusoidal error signal is obtained through band-pass amplification, phase identification, and low-pass filtering. The sinusoidal error signal is the electrical signal containing the repetition rate of the optical frequency comb and the phase difference of the microwave reference signal is converted into a sinusoidal error signal with sinusoidal characteristics, and usually the signal has asymmetry. The sinusoidal error signal (usually asymmetrical) is converted from the phase difference between an electrical signal containing the repetition rate of the optical frequency comb and a microwave reference signal, and has sinusoidal characteristics.

The sinusoidal error signal is subjected to the input bias adjustment to be input to the cavity length adjusting actuator precision control system, and undergoes the output bias adjustment to realize the precise locking of the optical frequency comb. The cavity length adjusting actuator precision control system is essentially a PI controller with high dynamic response, which can realize a dynamic adjustment of the optical frequency comb repetition rate in kHz order to lock the optical frequency comb with high precision. For an optical frequency comb with a repetition rate of 100M, the dynamic adjustment range can be up to several kHz, and the adjustment precision can be up to the order of μHz.
(S3) When the locking state of the cavity length adjusting actuator is in a critical threshold state, the repetition rate of the optical frequency comb is adjusted by adjusting the optical delay line of the optical frequency comb optical system in order to maintain the locking of the cavity length adjusting actuator to the repetition rate of the optical frequency comb.

In an embodiment, the step (S3) includes the following steps.

The second electrical signal output from the cavity length adjusting actuator is converted into a voltage characteristic signal by the optical delay line control system.

The optical delay line control system determines that the locking state of the cavity length adjusting actuator is in the critical threshold state according to the voltage characteristic signal, when the locking state of the cavity length adjusting actuator is in the critical threshold state, the optical delay line of the optical comb optical system is adjusted to adjust the repetition rate of the optical frequency comb.

The second electrical signal output from the cavity length adjusting actuator is converted into a voltage characteristic signal by the optical delay line control system. The optical delay line control system determines that the locking state of the cavity length adjusting actuator is in a critical threshold state according to the voltage characteristic signal, and the optical delay line of the optical comb optical system is adjusted to adjust the repetition rate of the optical frequency comb.

The lock state of the cavity length adjusting actuator precision control system is judged by the optical delay line auxiliary control system in real time. When the locking state is in the threshold, the optical delay line auxiliary control system is started to slowly adjust the optical frequency comb repetition rate in a wide range to maintain the locking of the optical frequency comb. The optical delay line auxiliary control system realizes the ultra-wide-bandwidth, wide-range adjustment of the optical frequency comb repeat frequency, and can realize the repeat frequency adjustment range as high as 100 kHZ without affecting the optical frequency comb mode locking.

In order to enable those skilled in the art to better understand the technical solution of the present disclosure, the signal transmission process of the present disclosure is hereinafter described in conjunction with the FIGURE.

The pump source injects pump light into the optical frequency comb optical system, which performs optical transformations such as optical enhancement and nonlinear phase shift on the pump light, and the optical frequency comb completes the mode locking.

The optical frequency comb optical system outputs an optical signal with repetition rate characteristics, i.e., repetition rate signal, which is converted into an electrical signal with repetition rate characteristics (i.e., the first electrical signal) through the photodetector. A fundamental signal or a high order harmonic signal with the characteristics of optical comb repetition rate is extracted by the electrical signal through the band-pass amplifier module. and is amplified followed by outputting to the phase discriminator to compare with the reference frequency phase to obtain the phase difference. After a low-pass filter, a sinusoidal signal with the phase difference between the optical frequency comb repetition rate and the reference frequency is obtained. The sinusoidal signal is transmitted to a fast PI controller, which outputs a first arithmetic signal to a PZT actuator, which drives and controls the amount of PZT expansion, and quickly adjusts the optical frequency comb repetition rate to complete the locking. The control accuracy reaches μHz level, and the control range reaches several kHz. The control output voltage of the PI controller is 0˜10V, and the control voltage converted to the PZT actuator is 0˜150V.

The other way of the fast PI controller outputs the second electrical signal to the voltage conversion circuit, which is converted into a voltage characteristic signal suitable for microprocessor sampling. The microprocessor carries out a real-time judgment of the voltage characteristic signal. When the voltage characteristic signal is close to the control threshold of the cavity length adjusting actuator precision control system, the low-speed PI controller for optical delay line control is turned on. The low-speed PI controller input for the microprocessor sampled signals, output the second operation to control the optical delay line actuator and the repetition rate of the optical comb is slowly adjusted to a proper position over a wide range. The characteristic of the suitable position is that the output of the fast PI controller of the cavity length adjusting actuator precision control system is satisfied near 5V. At this time, the output of the delay line actuator is kept unchanged and the low-speed PI controller is turned off. This adjustment method enables the optical frequency comb repeat frequency to be adjusted within a range of 100 kHz. Thus, a long time and high precision locking repetition rate of the optical frequency comb is realized by dual control system with cavity length adjusting actuator precision control system and optical delay line control system.

The present disclosure further provides an optical frequency comb repetition rate locking device, including:
a cavity length adjusting actuator control system; and
an optical delay line control system.

The cavity length adjusting actuator control system is configured to lock the repetition rate of the optical frequency comb.

The optical delay line control system is configured to adjust an optical delay line of an optical frequency comb optical system to adjust the repetition rate of the optical frequency comb when a locking state of the cavity length adjusting actuator control system is in a critical threshold state, so as to maintain locking of the repetition rate of the optical frequency comb.

In an embodiment, the repetition rate locking device further includes the optical frequency comb optical system configured for outputting a repetition rate signal to the cavity length adjusting actuator control system.

In an embodiment, the cavity length adjusting actuator control system includes:
a photodetector;
a band-pass amplifier module;
a phase discriminator;
a low-pass filter;
a fast proportional-integral (PI) controller; and
a piezoelectric ceramic (PZT) actuator.

The photodetector is configured for converting the repetition rate signal into a first electrical signal. The band-pass amplifier module is configured for extracting a fundamental signal or a high-order harmonic signal according to the first electrical signal and performing amplification processing on the fundamental signal or the high-order harmonic signal.

The phase discriminator is configured for performing phase discriminating on an amplified fundamental signal or an amplified high-order harmonic signal to obtain a phase difference between the repetition rate signal and a reference frequency signal.

The low-pass filter is configured for filtering the phase difference to obtain a sinusoidal error signal for characterizing the phase difference between the repetition rate signal and the reference frequency signal.

The fast PI controller is configured for obtaining a first operation signal based on the sinusoidal error signal and outputting the first operation signal to the PZT actuator.

The PZT actuator is configured for driving an amount of expansion and contraction of a piezoelectric ceramic for controlling the optical frequency comb optical system to accomplish locking of the repetition rate locking of the optical frequency comb.

In an embodiment, the optical delay line control system includes:
a voltage conversion circuit;
a microprocessor;
a low-speed PI controller; and
an optical delay line actuator.

The voltage conversion circuit is configured for receiving a second electrical signal output from the fast PI controller of the cavity length adjusting actuator control system and converting the second electrical signal into a voltage characteristic signal.

The microprocessor is configured for performing real-time sampling on the voltage characteristic signal for judgment, and outputting a sampled signal to the low-speed PI controller when the voltage characteristic signal is close to a control threshold of the cavity length adjusting actuator control system.

The low-speed PI controller is configured for obtaining a second operation signal based on the sampled signal and outputting the second operation signal to the optical delay line actuator.

The optical delay line actuator is configured for adjusting the optical delay line of the optical frequency comb optical system to achieve adjustment of the repetition rate signal.

In an embodiment, the optical delay line is adjusted such that a voltage value of the voltage characteristic signal is 5 V. An adjustment action of optical delay line actuator unchanged, and the low-speed PI controller is turned off to accomplish adjustment of the repetition rate signal.

In practical procedures, the voltage value of the voltage characteristic signal is around 5V (i.e., the voltage characteristic signal critical in the cavity length adjusting actuator control system control threshold), and the specific voltage value needs to be judged by the operator according to the actual situation.

In summary, the present disclosure provides an optical frequency comb repetition rate locking method and device, in which a dual-control system integrating the precision control of the cavity length adjusting actuator and the auxiliary control of the optical delay line is adopted to realize a high-precision and long-time locking of the optical frequency comb repetition rate in the field measurement. This application is applicable to the ultra-wide-bandwidth and wide-range locking of the optical frequency comb repetition rate under a field scenario. Compared with the prior art, the present disclosure integrates phase identification, filtering, and control to realize the long-time precision locking of the repetition rate of the optical frequency comb. The phase identification using a sinusoidal phase discriminator, to obtain an error signal with sinusoidal signal characteristics. The error signal is relatively smooth, so that the optical frequency comb repeat frequency locking easier to carry out. The cavity length adjusting actuator precision control system realizes the precision locking of the optical frequency comb repetition rate, and the actuator device used is PZT, which can realize the dynamic adjustment of the optical frequency comb repetition rate of the order of kHz, and it also has a relatively large frequency adjustment range. The optical delay line control system is configured to adjust the repetition rate of the optical frequency comb in a wide range, the adjustment range reaches the level of 100 kHz, realizing the long time locking of the optical frequency comb, ultimately the system meets the precision locking of the optical frequency comb in a wide range of the ultra-wide-bandwidth to ensure that the measurement activities based on the optical frequency comb can be carried out under the field conditions.

The above embodiments only describe the design principle of the present disclosure, and shapes and names of the components involved therein can be different. Therefore, for those skilled in the art, various modifications and changes can be made to the foregoing embodiments of the present disclosure. It should be understood that any modification, equivalent substitution and improvement made without departing from the spirit and principle of the present disclosure should be included within the scope of the present disclosure defined by the appended claims.

What is claimed is:

1. A method for locking a repetition rate of an optical frequency comb, comprising:
(S1) locking the repetition rate of the optical frequency comb with a cavity length adjusting actuator; and
(S2) when a locking state of the cavity length adjusting actuator is in a critical threshold state, adjusting the repetition rate of the optical frequency comb by adjusting an optical delay line of an optical frequency comb optical system to keep locking the repetition rate of the optical frequency comb.

2. The method of claim 1, wherein prior to step (S1), the method further comprises:
outputting, by the optical frequency comb optical system, a repetition rate signal to the cavity length adjusting actuator.

3. The method of claim 2, wherein the step (S1) comprises:
(S11) based on the repetition rate signal, obtaining a sinusoidal error signal for characterizing a phase difference between the repetition rate signal and a reference frequency signal; and
(S12) adjusting the repetition rate signal according to the sinusoidal error signal to complete locking of the repetition rate of the optical frequency comb.

4. The method of claim 3, wherein the step (S11) comprises:
converting the repetition rate signal into an electrical signal;
obtaining a fundamental signal or a high-order harmonic signal according to the electrical signal, and amplifying the fundamental signal or the high-order harmonic signal;
performing phase discrimination on an amplified fundamental signal or an amplified high-order harmonic signal to obtain the phase difference; and
filtering the phase difference to obtain the sinusoidal error signal.

5. The method of claim 1, wherein the step (S2) comprises:
converting, by an optical delay line control system, a second electrical signal output from the cavity length adjusting actuator into a voltage characteristic signal;
determining, by the optical delay line control system, whether the locking state of the cavity length adjusting actuator is in the critical threshold state based on the voltage characteristic signal, wherein when the locking state of the cavity length adjusting actuator is in the critical threshold state, the optical delay line of the optical frequency comb optical system is adjusted to adjust the repetition rate of the optical frequency comb.

6. A device for locking a repetition rate of an optical frequency comb, comprising:
a cavity length adjusting actuator control system; and
an optical delay line control system;
wherein the cavity length adjusting actuator control system is configured to lock the repetition rate of the optical frequency comb; and
the optical delay line control system is configured to adjust an optical delay line of an optical frequency comb optical system to adjust the repetition rate of the optical frequency comb when a locking state of the cavity length adjusting actuator control system is in a critical threshold state, so as to maintain locking of the repetition rate of the optical frequency comb.

7. The device of claim 6, further comprising:
the optical frequency comb optical system;
wherein the optical frequency comb optical system is configured for outputting a repetition rate signal to the cavity length adjusting actuator control system.

8. The device of claim 6, wherein the cavity length adjusting actuator control system comprises:
a photodetector;
a band-pass amplifier module;
a phase discriminator;
a low-pass filter;
a first proportional-integral (PI) controller; and
a piezoelectric ceramic (PZT) actuator;
wherein the photodetector is configured for converting the repetition rate signal into a first electrical signal;
the band-pass amplifier module is configured for extracting a fundamental signal or a high-order harmonic signal from the first electrical signal, and amplifying the fundamental signal or the high-order harmonic signal;
the phase discriminator is configured for performing phase discrimination on an amplified fundamental signal or an amplified high-order harmonic signal to obtain a phase difference between the repetition rate signal and a reference frequency signal;
the low-pass filter is configured for filtering the phase difference to obtain a sinusoidal error signal for characterizing the phase difference between the repetition rate signal and the reference frequency signal;
the first PI controller is configured for obtaining a first operation signal based on the sinusoidal error signal, and outputting the first operation signal to the PZT actuator; and
the PZT actuator is configured for driving expansion and contraction of a piezoelectric ceramic for controlling the optical frequency comb optical system to accomplish locking of the repetition rate of the optical frequency comb.

9. The device of claim 8, wherein the optical delay line control system comprises:
a voltage conversion circuit;
a microprocessor;
a second PI controller; and
an optical delay line actuator;
wherein the voltage conversion circuit is configured for receiving a second electrical signal output from the first PI controller, and converting the second electrical signal into a voltage characteristic signal;
the microprocessor is configured for performing real-time sampling on the voltage characteristic signal for judgment, and outputting a sampled signal to the second PI controller when a difference between the voltage characteristic signal and a control threshold of the cavity length adjustment actuator control system is within a preset range;
the second PI controller is configured for obtaining a second operation signal based on the sampled signal, and outputting the second operation signal to the optical delay line actuator; and
the optical delay line actuator is configured for adjusting the optical delay line of the optical frequency comb optical system to achieve adjustment of the repetition rate signal.

10. The device of claim 9, wherein the optical delay line is adjusted such that a voltage value of the voltage characteristic signal is 5 v; and an adjustment action of the optical delay line actuator is kept unchanged, and the second PI controller is turned off to accomplish adjustment of the repetition rate signal.
